(19) United States
(12) Patent Application Publication
(10) Pub. No.: US 2024/0185303 A1
(43) Pub. Date: Jun. 6, 2024

(54) ADVERTISEMENT MANAGEMENT SYSTEM AND ADVERTISEMENT MANAGEMENT METHOD

(71) Applicant: Sharp NEC Display Solutions, Ltd., Tokyo (JP)

(72) Inventor: Shinya UEDA, Tokyo (JP)

(21) Appl. No.: 18/279,374

(22) PCT Filed: Jun. 15, 2021
(86) PCT No.: PCT/JP2021/022638

§ 371 Date: Aug. 29, 2023

(51) Int. Cl. G06Q 30/0272

(52) U.S. Cl. CPC G06Q 30/0272

(57) ABSTRACT

An acquirer configured to acquire posted data corresponding to at least one of advertising spaces shown in a location where a display device for displaying an advertisement is installed or a period when the advertisement is displayed within posted data posted from a terminal device of a user; and an analyzer configured to calculate a matching degree between a posted element obtained from the acquired posted data and an advertisement element according to the advertisement are provided.

### TECHNICAL FIELD

The present invention relates to an advertisement management system and an advertisement management method.

### BACKGROUND ART

Although advertising by paper media is conventionally performed, advertising by digital signage that displays advertisements on a display is becoming mainstream. A person who wants to display advertisements (an advertising consignor) is allowed to display the advertisements on a display by paying an advertising fee to a manager (a facility manager or the like) who installs the display in the facility or the like, an advertising agency that mediates the advertisements, or the like.

A unit price of an advertisement is determined by a time period when the advertisement is displayed and a location where the display is installed (an advertising space). The unit price of this advertisement is often determined from information such as the number of people at the location where the display is installed and the day of the week. Because there tends to be a higher expectation that people will view advertisements in locations with much pedestrian traffic, the unit price of advertisements tends to be higher. Also, a display holder uses a subjective element such as information about an amount of pedestrian traffic or the day of the week to determine the unit price of an advertising space.

Here, if an advertiser causes a display installed at a location with much pedestrian traffic to display advertisements, the number of people who will view the advertisements can be expected to increase as pedestrian traffic increases. However, even if many people pass by, it is difficult to know how many people actually viewed advertisements.

Therefore, a system for quantitatively obtaining a situation in which advertisements are viewed by imaging people near a display using an imaging device, extracting a face image from a captured image, and measuring whether or not an advertisement is viewed, a viewing time, and the like has also been proposed (see Patent Document 1).

### CITATION LIST

### Patent Document

### [Patent Document 1]

Japanese Unexamined Patent Application, First Publication No. 2011-70629

### SUMMARY OF INVENTION

### Technical Problem

However, when it is necessary to provide an imaging device in such a system and the number of displays is large, there is a problem that the number of imaging devices must also be increased and a process of analyzing a watching state from a captured image is also complicated.

### Solution to Problem

One aspect of the present invention is an advertisement management system including: an acquirer configured to acquire posted data corresponding to at least one of advertising spaces shown in a location where a display device for displaying an advertisement is installed or a period when the advertisement is displayed within posted data posted from a terminal device of a user; and an analyzer configured to calculate a matching degree between a posted element obtained from the acquired posted data and an advertisement element according to the advertisement.

In addition, one aspect of the present invention is an advertisement management method to be executed by a computer, the advertisement management method including: executing a process of acquiring posted data corresponding to at least one of advertising spaces shown in a location where a display device for displaying an advertisement is installed or a period when the advertisement is displayed within posted data posted from a terminal device of a user; and executing, by an analyzer, a process of calculating a matching degree between a posted element obtained from the acquired posted data and an advertisement element according to the advertisement.

### Advantageous Effects of Invention

According to the present invention, it is also possible to ascertain a situation in which an advertisement is watched without using an imaging device and without performing a complicated process based on a captured image.

### BRIEF DESCRIPTION OF DRAWINGS

FIG. 1 is a schematic block diagram showing a configuration of an advertisement management system 1.

FIG. 2 is a schematic block diagram showing functions of an analysis server 30 and an advertisement server 40.

FIG. 3 is a diagram showing an example of a data structure of an SNS information table.

FIG. 4 is a diagram showing an example of an advertising space table.

FIG. 5 is a diagram showing an example of an advertisement table.

FIG. 6 is a diagram showing an example of a distribution schedule table.

FIG. 7 is a flowchart for describing the overall flow of the advertisement management system 1.

FIG. 8 is a diagram showing an example of a text analysis result table.

FIG. 9 is a diagram showing an example of a photo analysis result table.

FIG. 10 is a diagram showing an example of a weighting calculation table.

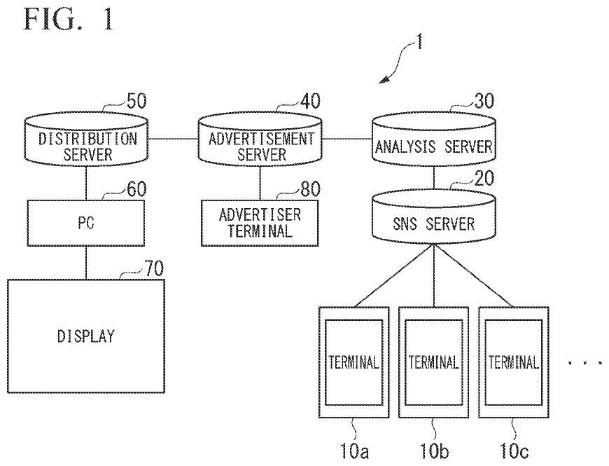

FIG. 1I is a diagram showing an example of an advertising space number determination table.

FIG. 12 is a diagram showing an example of a post-determination advertising space table.

FIG. 13 is a schematic block diagram showing a configuration of an advertisement management system 1A according to another embodiment.

### DESCRIPTION OF EMBODIMENTS

Hereinafter, an advertisement management system according to an embodiment of the present invention will be described with reference to the drawings, FIG. 1 is a schematic block diagram showing a configuration of an advertisement management system 1 according to an embodiment of the present invention. The advertisement management system 1 includes a plurality of terminals (a terminal 10a, a terminal 10b, and a terminal 10c), a social network service (SNS) server 20, an analysis server 30, an advertisement server 40, a distribution server 50, a personal computer (PC) 60, a display 70, and an advertiser terminal 80.

The plurality of terminals (the terminal 10a, the terminal 10b, and the terminal 10c) are each communicatively connected to the SNS server 20 via a wireless or wired link or the like.

The terminal 10a, the terminal 10b, or the terminal 10c is a terminal device used by the user and may be, for example, a smartphone or a tablet. Here, the terminal 10a, the terminal 10b, or the terminal 10c is shown as a terminal and four or more terminals may be used. Also, when the terminal 10a, the terminal 10b, and the terminal 10c are not specifically identified, they may be simply referred to as the terminal 10.

The terminal 10 has a function of inputting posted data input by the user via an input device such as a touch panel and transmitting the posted data to the SNS server 20. The posted data transmitted to the SNS server 20 is stored in the SNS server 20.

Also, the terminal 10 has a function of receiving and outputting posted data posted by another terminal 10 transmitted from the SNS server 20. The output of the posted data can be displayed on a display screen of the terminal 10 or a sound thereof can be output from a speaker of the terminal 10. Also, the terminal 10 has a camera function and can generate image data corresponding to the taken photo, include the image data in the posted data, and transmit the posted data to the SNS server 20.

The SNS server 20 is communicatively connected to a plurality of terminals 10 and an analysis server. The SNS server 20 distributes comment data posted from the terminal 10 to another terminal 10 different from the terminal 10 from which the comment data has been posted. The comment data includes at least one of text data and image data. The image data is data of a photo taken by a camera.

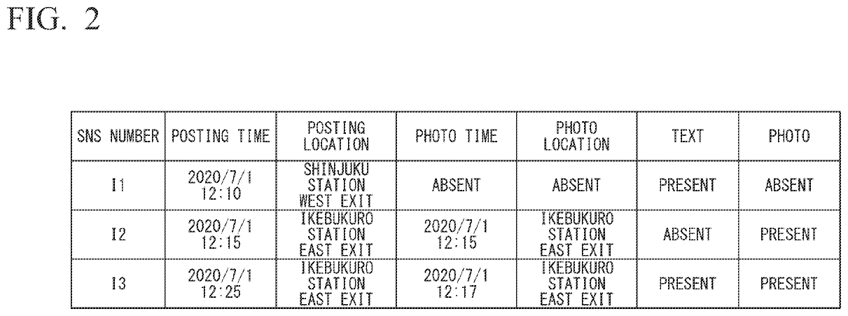

Next, the analysis server 30 and the advertisement server 40 will be described using FIG. 2.

FIG. 2 is a schematic block diagram showing functions of the analysis server 30 and the advertisement server 40.

The analysis server 30 is communicatively connected to the SNS server 20 and the advertisement server 40. The analysis server 30 analyzes comments posted to the SNS server. The analysis server 30 includes an SNS acquirer 301, an SNS analyzer 302, and an SNS information table storage 303.

The SNS acquirer 301 establishes a connection by communicating with the SNS server 20 and acquires posted data from the SNS server 20.

The SNS analyzer 302 has a function of analyzing the posted data acquired by the SNS acquirer 301, storing an analysis result in the SNS information table storage 303, and outputting the analysis result to the advertisement server 40.

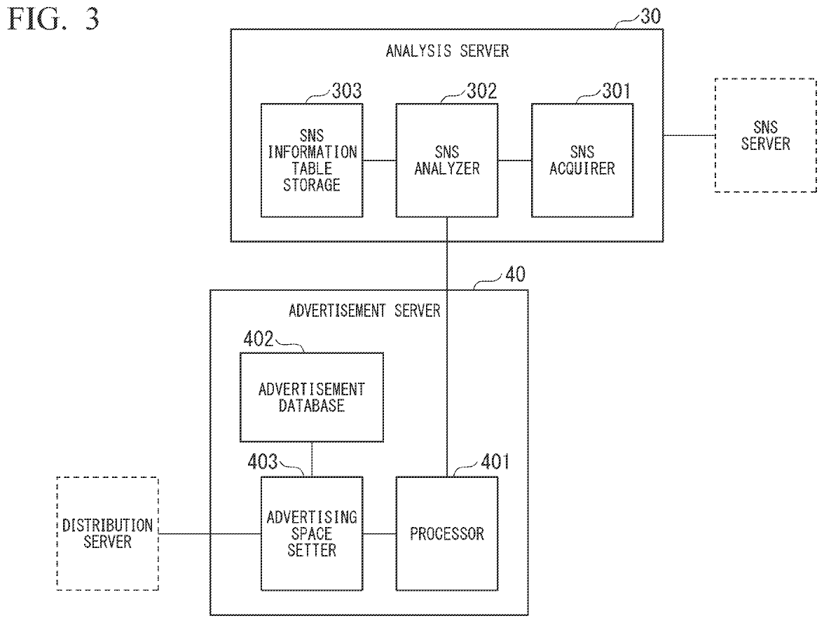

The SNS information table storage 303 stores an SNS information table, FIG. 3 is a diagram showing an example of a data structure of the SNS information table stored in the SNS information table storage 303.

The SNS information table includes items of an SNS number, a posting time, a posting location, a photo time, a photo location, text, and a photo.

The SNS number is identification information for identifying posted data. The posting time is the time when the posted data was transmitted by the terminal 10. For this posting time, the time when the SNS server 20 received the posted data from the terminal 10 may be used. As the posting location, location information indicating a current location of the terminal 10 when the terminal 10 has posted the posted data is used. For example, the terminal 10 has a location measurement function, includes the location information obtained by the location measurement function as a posting location in the posted data when posted data is posted, and transmits the posted data. As this location measurement function, for example, the Global Positioning System (GPS) may be used.

The photo time indicates the time when the photo was taken. The photo location is data in which location information obtained in the location measurement function is assigned to the image when the photo is taken by the terminal 10. For example, the photo location can be assigned to the image data as exchangeable image file format (Exif) information.

The text indicates whether or not text is included in the posted data. The photo indicates whether or not photo data is included in the posted data. Here, the posted data transmitted from the terminal 10 is assigned an SNS number by the SNS server 20 and stored within the SNS server 20. Here, the SNS information table and the posted data are associated with the SNS number.

Here, because the posted content is managed as a set of data in the SNS information table, even if the posting time and the photo time do not match or the posting location and the photo location do not match, it can be managed as one piece of data.

Also, the content posted by users on the SNS may have no text and only photos, or there may be text but no photos. In such posted data, data indicating that there is no text is stored in the SNS information table when there is no text in the posted data, and data indicating that there is no photo is stored in the SNS information table when there is no photo in the posted data.

The advertisement server 40 is connected to the analysis server 30 and the distribution server 50.

The advertisement server 40 includes a processor 401, an advertisement database 402, and an advertising space setter 403.

The processor 401 has a function of acquiring an analysis result from the SNS analyzer 302, a function of processing the analysis result obtained on the basis of the analysis result, and a function of controlling the advertisement server 40. The advertisement database 402 stores advertisement data obtained from an advertising consignor. Distribution of the advertisement data is requested by the advertiser (the advertising consignor) and that data is stored in the advertisement database 402. In the advertisement database 402, for example, an advertising space table and an advertisement table are stored.

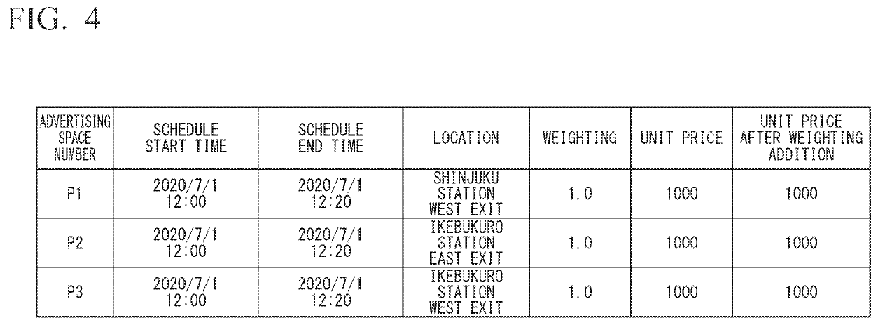

FIG. 4 is a diagram showing an example of an advertising space table stored in the advertisement database 402 of the advertisement server 40. The advertising space table includes the following items: an advertising space number, a schedule start time, a schedule end time, a location, a weighting, a unit price, and a unit price after a weighting addition.

The advertising space number is identification information for identifying the advertising space. The schedule start time is a start time at which the advertisement is distributed. The schedule end time is an end time when the advertisement distribution ends. The location is a location where the display 70 of an advertisement distribution target is installed. The weighting is a weighting for the unit price. The unit price is a unit price required to distribute an advertisement.

The unit price after the weighting addition is the unit price after calculation is performed on the basis of the unit price and the weighting. For example, the unit price after the weighting addition is obtained by multiplying the unit price by the weighting. In the advertising space table, the schedule start time, the schedule end time, the location, and the unit price are determined by a contract between the advertising consignor and the advertising agency. The weighting is registered with an initial value (for example, “1.0”).

For example, for advertisement number “P1,” the schedule start time is “2020/07/01/12:00,” the schedule end time is “2020/07/01/12:20,” the distribution to the display 70 installed at “Shinjuku Station West Exit” is performed, and the unit price is “1000” (yen). The weighting is registered as “1.0” and the unit price after the weighting addition is “1000” (yen).

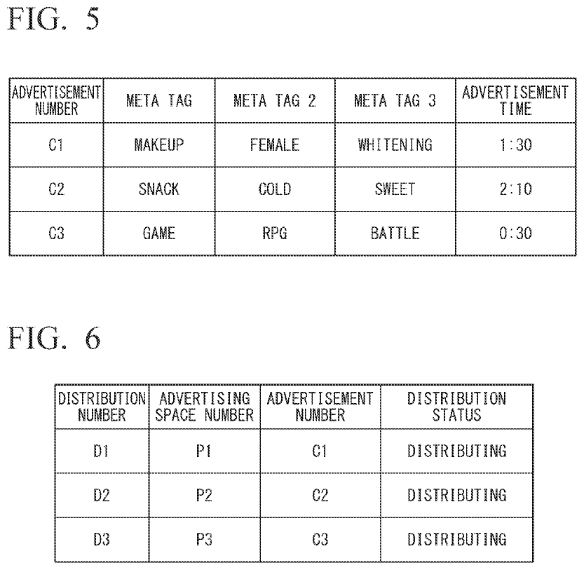

FIG. 5 is a diagram showing an example of an advertisement table stored in the advertisement server 40.

A meta tag is set in the advertisement.

The advertisement table includes items such as an advertisement number, meta tags (meta tags 1 to 3), and an advertisement time. Here, in the meta tag items, setting of three meta tags is illustrated, but the number thereof may be any of one, two, or four or more. For the meta tags, for example, words related to advertisements are used. Advertisement number “C1” is associated with meta tag 1 “makeup,” meta tag 2 “female,” meta tag 3 “whitening,” and advertising time “1:30.” In this way, it is possible to understand what meta tags are related to advertisements. If the text included in the posted data includes keywords that match these meta tags, a matching degree is calculated.

The advertising space setter 403 sets the advertising space. The advertising space setter 403 generates an advertising space for distributing advertisement data. The advertising space includes data that defines a time period when advertisement data is distributed. The advertising space setter 403 has a function of reading advertisement data from the advertisement database 402 and a function of setting the unit price and setting the advertising space on the basis of analysis results of the analysis server 30. The advertising space setter 403 transmits the advertisement data and the advertising space to the distribution server 50.

Returning to FIG. 1, the distribution server 50 is connected to the advertisement server 40 and the PC (computer) 60. The distribution server 50 distributes advertisement data to the display 70 via the PC 60 or the like according to a schedule of the set advertising space.

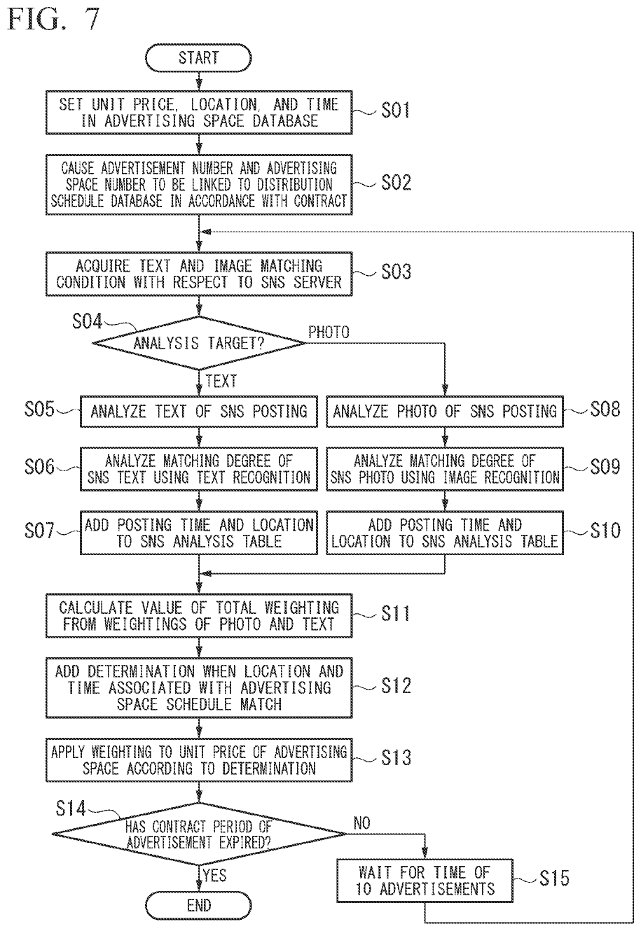

FIG. 6 is a diagram showing an example of a distribution schedule table stored in the distribution server 50. The distribution schedule table is data including items of a distribution number, an advertising space number, an advertisement number, and distribution status. The distribution number is identification information for identifying a distribution management target. The distribution status indicates a distribution situation. For example, for distribution number “D1,” it is indicated that advertisement data of advertisement number “C1” is being distributed (distribution status is “distributing”) in distributing space number “P1.”

The PC 60 is connected to the distribution server 50 and the display 70. The PC is, for example, a computer. The PC 60 outputs advertisement data received from the distribution server 50 to the display 70.

The display 70 is connected to the PC 60. The display 70 displays a video signal included in the advertisement data on the display screen. The display also outputs an audio signal from the speaker when the advertisement data includes the audio signal. The display 70 is installed at a public location, in front of a station, or the like. The video signal or the audio signal of the advertisement data output from the display can be viewed or listened to by a plurality of users.

Although one display 70 is shown in FIG. 1, a plurality of displays 70 may be connected to one PC 60 or at least one display 70 may be connected to each PC 60 if there are a plurality of PCs 60.

The analysis server 30, the advertisement server 40, the distribution server 50, the PC 60, and the display 70 are managed by, for example, an advertising agency.

The advertiser terminal 80 is used by the advertiser. The advertiser terminal 80 is communicatively connected to the advertisement server 40. The advertiser terminal 80 executes a contract regarding the use of the advertising space with an advertisement agency or the like and transmits target advertisement data to be displayed in the advertising space to the advertisement server 40. Also, the advertiser terminal 80 transmits information necessary for the advertisement table to be described below to the advertisement server 40 in accordance with an operation input of an operator. Also, the advertiser terminal 80 receives data transmitted from the advertisement server 40 and displays the data on the display screen. A plurality of advertiser terminals 80 may be provided. For example, when there are a plurality of advertisers, the advertiser terminal 80 may be owned to be able to be used by each advertiser. The advertiser terminal 80 may be any of a smartphone, a tablet, a computer, and the like.

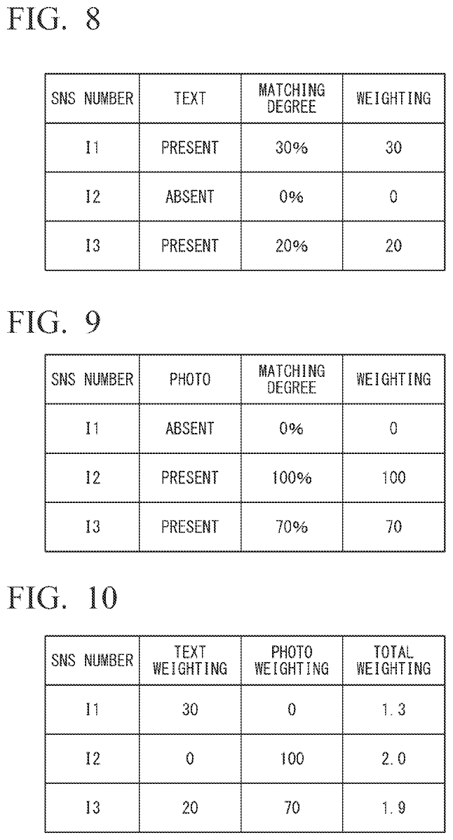

Next, the overall flow of the advertisement management system 1 will be described using a flowchart of FIG. 7. Here, a contract is executed in advance between the advertising consignor and the advertising agency and a distribution schedule is determined on the basis of the contract.

### <Step S01>

The advertising agency creates an advertising space table including a unit price of an advertisement, a location where the advertisement is distributed, a time when the advertisement is distributed, and the like according to contract content, and writes the advertising space table in an advertising space database of the advertisement server 40. The advertisement server 40 stores the advertising space table in the advertising space database in accordance with an operation input of the operator of the advertising agency.

### <Step S02>

The distribution server 50 associates the advertisement number of the advertisement table (FIG. 5) stored in the advertisement database and the advertising space number of the advertising space database (FIG. 4) with the distribution schedule database (FIG. 6) in accordance with a contract between the advertiser and the advertisement distributor and the like and links them. For example, the distribution server 50 writes advertisement number “C1” with respect to distribution number “D1” and therefore causes advertisement number “C1” in the advertisement table to be associated therewith.

### <Step S03>

The SNS acquirer 301 of the analysis server 30 acquires posted data (here, text and an image) matching a condition from the SNS server 20 by performing a filtering process and stores the acquired posted data in the SNS information table storage 303 (step S03). The SNS acquirer 301 determines that the posted data is posted data matching the condition in the case of the posted data including a word matching at least one of meta tags stored in the advertisement table and stores the posted data in the SNS information table storage 303. Also, the SNS acquirer 301 performs image recognition on the basis of the photo included in the posted data. When the posted data is posted data matching the condition (for example, including a photo related to the advertisement) on the basis of a recognition result, the SNS acquirer 301 stores the posted data in the SNS information table storage 303. Here, the SNS acquirer 301 stores information indicating a case where text is included in the posted data matching the condition as “present” and information indicating a case where there is no text therein as “absent” in the SNS information table storage 303 and stores information indicating a case where a photo is included in the posted data matching the condition as “present” and information indicating a case where there is no photo therein as “absent” in the SNS information table storage 303.

### <Step S4>

The SNS analyzer 302 refers to the SNS information table stored in the SNS information table storage 303 and determines whether the analysis target is text or a photo on the basis of the presence or absence of text and an image within the posted data with respect to the posted data of the corresponding SNS number.

In the SNS information table, the SNS analyzer 302 moves the process to step S05 in the case of the posted data in which the text is “present” and the photo is “absent” in the SNS information table and moves the process to step S08 in the case of the posted data in which the text is “absent” and the photo is “present.” The SNS analyzer 302 may be configured to perform both the processing of steps S05 to S07 and the processing of steps S08 to S10 when both the text and photo are “present.”

### <Step S05>

When it is determined that the analysis target is text (step S04—text), the SNS analyzer 302 extracts an SNS number and posted data corresponding to the SNS number from the SNS information table and analyzes the SNS number and the posted data.

### <Step S06>

The SNS analyzer 302 determines how many meta tags stored in the advertisement table match the text of the extracted posted data with respect to a combination of meta tags corresponding to an advertisement number in the advertisement table and determines a matching degree.

For example, the SNS analyzer 302 extracts a string (for example, a word) by performing linguistic analysis on the text included in the posted data and determines whether or not the extracted word matches the meta tag. For example, if the meta tag is “sweet” and the text includes “sweet,” it is determined that “sweet” matches. Also, if the meta tag is “sweet” and “sweetness” is included in the text, it may be determined that “sweetness” also matches when there is relevance on the basis of relevance between “sweet” and “sweetness.”

The SNS analyzer 302 calculates a weighting corresponding to the matching degree of text on the basis of the following Eq. (1) on the basis of the number of matches.

(Weighting of text matching)=(Number of matching meta tags)/(Set number of meta tags) (1)

Here, the “number of matching meta tags” is the number of meta tags matching a word included in the text of the posted data among meta tags corresponding to one advertisement number in the advertisement table.

Here, “the set number of meta tags” is the number of meta tags corresponding to one advertisement number in the advertisement table.

For example, when the posted data includes the text “1 want to eat something sweet.” because the meta tag of “sweet” matches among meta tags in the advertisement number indicated by C2, the weighting of the text match of the posted data can be calculated as “⅓.”

### <Step S07>

When the SNS analyzer 302 calculates a weighting according to the matching degree, the SNS analyzer 302 generates a text analysis result table that is a result of analyzing the text and transmits the text analysis result table to the processor 401 of the advertisement server 40.

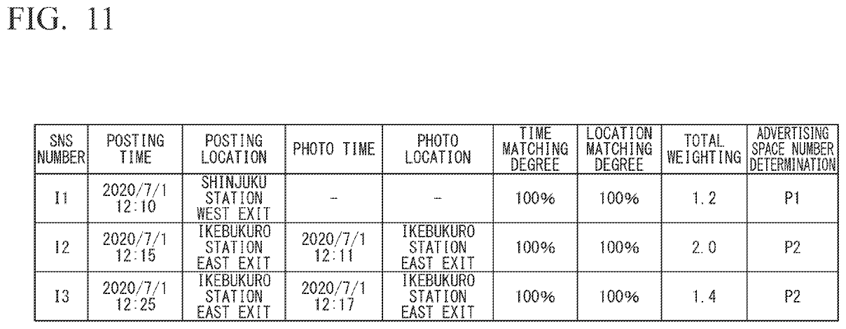

Here, FIG. 8 is a diagram showing an example of the text analysis result table. The text analysis result table includes an SNS number, text, a matching degree, and a weighting. The text analysis result table and the SNS information table are associated by an SNS number.

The text indicates whether or not there is text in the posted data indicated by the SNS number. The matching degree is a value calculated with the above Eq. (1). The weighting is a value obtained on the basis of, for example, the following Eq. (2), and is a value determined in accordance with the matching degree. When the matching degree is 30%, the weighting is calculated as 0.3.

(Weighting for matching degree of text)=(Matching degree of text)/100 (2)

In this text analysis result table, data of one row is generated for each SNS number.

When the matching degree and the weighting are calculated for posted data that is an analysis target, the SNS analyzer 302 transmits the text analysis result table stored in the SNS information table storage 303 to the processor 401 of the advertisement server 40.

### <Step S08>

On the other hand, when it is determined that the analysis target is a photo (step S04—Photo), the SNS analyzer 302 extracts the SNS number and the posted data corresponding to the SNS number from the SNS information table and analyzes the SNS number and the posted data.

### <Step S09>

The SNS analyzer 302 calculates the matching degree between the image included in the advertisement data and the photo included in the posted data by performing image analysis. The image included in the advertisement data may be an image displayed as an advertisement or an analysis image may be stored in advance in the advertisement table and a matching degree between the analysis image and the photo included in the posted data may be calculated. The matching degree may be a degree to which a feature amount of an image, a color, an object (or a person or the like) in a photo, or the like matches.

### <Step S10>

When the weighting according to the matching degree is calculated, the SNS analyzer 302 generates a photo analysis result table that is a result of analyzing the photo and transmits the photo analysis result table to the processor 401 of the advertisement server 40.

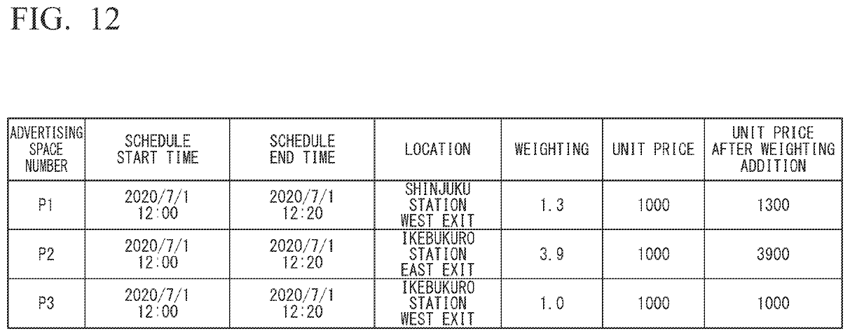

Here, FIG. 9 is a diagram showing an example of a photo analysis result table. The photo analysis result table includes an SNS number, a photo, a matching degree, and a weighting. The photo analysis result table and the SNS information table are associated by the SNS number.

The photo indicates whether or not there is a photo in the posted data indicated by the SNS number. The matching degree is a value indicating an image matching degree between the image included in the advertisement data and the photo included in the posted data. The weighting is a value determined by the matching degree. When the matching degree is 70%, the weighting is calculated as 0.7.

In this photo analysis result table, data of one row is generated for each SNS number.

When the image matching degree is calculated, the SNS analyzer 302 generates a weighting in accordance with the image matching degree and transmits the photo analysis result table to the processor 401 of the advertisement server 40. The weighting for the photo matching degree can be calculated from the following Eq. (3).

(Weighting for photo matching degree)=(Matching degree between advertising image and photo)/100 (3)

When the matching degree and weighting are calculated for posted data that is an analysis target, the SNS analyzer 302 transmits the photo analysis result table stored in the SNS information table storage 303 to the processor 401 of the advertisement server 40.

### <Step S11>

When the text analysis result table and the photo analysis result table are received from the SNS analyzer 302, the processor 401 of the advertisement server 40 calculates a total weighting value from weighting values of the photo and the text by inputting the result of the text analysis result table and the photo analysis result table to the weighting calculation table.

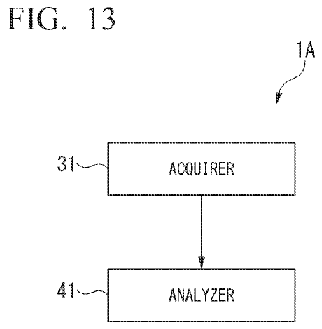

FIG. 10 is a diagram showing an example of the weighting calculation table. The weighting calculation table includes items of as an SNS number, a text weighting, a photo weighting, and a total weighting. The weighting calculation table may be stored in a storage area inside of the processor 401 or may be stored in a storage area inside of the advertisement server 40. The total weighting is a sum of the text weighting and the photo weighting. The total weighting can be calculated on the basis of the following Eq. (4).

(Total weighting)=((Weighting of text matching)+(Weighting of photo matching))/100+Initial value of weighting (4)

For example, for SNS number “I1,” the text weighting is “30,” the photo weighting is “0.” and the total weighting is “1.3.” The initial value of the weighting of SNS number “I1” is “1.0.”

### <Step S12>

The processor 401 adds a result from the SNS analyzer 302 to the advertising space number determination table.

Here, FIG. 11 is a diagram showing an example of the advertising space number determination table.

The advertising space number determination table includes items of a time matching degree, a location matching degree, a total weighting, and an advertising space number determination.

Data of the corresponding items in the SNS information table is used for an SNS number, a posting time, a posting location, a photo time, and a photo location.

In the data indicated in the row of SNS number “I1,” the posting time is “2020/07/01 12:10” and the posting location is “Shinjuku Station West Exit.” Data of the photo time and the photo location are blank, it is indicated that the posted data includes no photo.

The processor 401 refers to the SNS information table for the time matching degree and the location matching degree, calculates the location and time matching degrees, and adds values of the calculated matching degrees to the time matching degree and the location matching degree of the advertising space number determination table. Here, the processor 401 may be configured to calculate at least one of the time matching degree and the location matching degree.

For the time matching degree, a value corresponding to whether at least one of the posting time and the photo time is between the schedule start time and the schedule end time in the advertising space table is used. For example, the processor 401 calculates the time matching degree as “100%” when the posting time is between the schedule start time and the schedule end time in the advertising space table and calculates the time matching degree as “0%” when the posting time is not therebetween. This indicates that the time matching degree is 100% and the user is likely to have posted the posted data by viewing the advertisement displayed in the advertising space if the time when the posted data was posted corresponds to the advertising space. Also, when the photo time included in the posted data corresponds to the advertising space, it is indicated that the photo is likely to have been taken due to viewing the advertisement displayed in the advertising space and the posted data is likely to have been posted. When the time matching degree is “0%,” it can be seen that the posted data is likely to have been posted without being caused by viewing the advertisement from the time perspective.

For the location matching degree, a value according to whether or not the posting location included in the posted data corresponds to the location in the advertising space table is used. For example, the processor 401 calculates the location matching degree as “100%” when the posting location included in the posted data corresponds to a location in the advertising space table and calculates the location matching degree as “0%” when the posting location included in the posted data does not correspond thereto. This indicates that, when the location where the posted data has been posted corresponds to the location in the advertising space, the user is likely to have posted the posted data from a location where an advertisement can be watched or near the location by viewing the advertisement displayed in the advertising space. In this case, it is more likely that the user was actually watching the advertisement when there is a photo in the posted data and a photo matching degree is high to some extent than when there is no photo in the posted data and only text matches. It can also be estimated that the user was interested in the advertisement. Thus, the weighting value may be set so that the weighting value of the posted data including the photo is larger than that of the posted data including only the text.

For the total weighting, a value stored in the weighting calculation table can be used. Here, the processor 401 may use the value stored in the weighting calculation table as it is for the total weighting, determine the presence or absence of a photo in the posted data of a meta tag, a matching degree between an advertising image and a photo, and the like, correct a value stored in the weighting calculation table in accordance with determination results, and designate the corrected value as the total weighting.

When the total weighting is corrected, the total weighting may be corrected on the basis of a matching degree between a string of the meta tag and a string of the text included in the posted data. In addition, when the total weighting is corrected, the total weighting may be corrected on the basis of a matching degree between the advertising image and the photo included in the posted data.

For example, in a case where, for SNS number “I1,” the posted data is posted data without a photo, but there is posted data including a string corresponding to a meta tag of advertisement data in a time period of the advertising space (between the schedule start time and the schedule end time), there is a possibility of posting for a product displayed when the advertisement data is displayed. Also, even if the posting is not posting for a product of the advertisement itself, it is possible to estimate that a user who is interested or is likely to be interested in the advertisement was at a location where an advertisement has been played if the string included in the text of the posted data matches the string of the meta tag. Here, even if the posting time and the posting location match, it is not necessarily likely that the text was actually posted because the advertisement was viewed at the location when only text was posted (when there was no photo). In this case, the total weighting may be corrected to a smaller value.

Also, when the meta tag is “sweet” and “sweetness” is included in the text, the total weighting may be corrected in accordance with the matching degree between “sweet” and “sweetness.”

Also, when the posted data is posted data in which there is a photo for SNS number “I3” but an image matching degree between the advertising image and the photo is somewhat low, an influence on an addition target may be slightly low. That is, even if the photo time and the photo location match, the total weighting may be corrected to a small value when another subject as well as the object of the photo taken for the advertisement (or an object related to the advertisement) is included.

In the item for determining the advertising space number, the posted data indicated by the SNS number represents the advertising space number of the advertisement that is highly relevant among the advertisements indicated by the advertising space numbers.

The processor 401 calculates a value of the total weighting on the basis of at least one of the time matching degree and the location matching degree, the determination of the presence or absence of a photo, and a text matching degree with reference to the advertising space number determination table. For example, because the combination of the posting time and the posting location corresponds to a combination of a time between the schedule start time and the schedule end time and a location in advertising space number “P1” in the advertising space table for SNS number “I1” in the advertising space number determination table, it is determined that relevance is highest with respect to advertising space number “P1” in the advertising space table in the posted data of SNS number “I1.” Thereby, the processor 401 writes “P1” in the advertising space number determination in SNS number “I1.”

Here, SNS number “I1” and SNS number “I3” will be further described in the advertising space number determination table. Although SNS number “I3” is related to a posting time of “12:25” and a posting location of “Ikebukuro Station East Exit” in the advertising space number determination table, there is no advertising space data included in the advertising space time of “12:25” in “Ikebukuro Station East Exit” in the advertising space table. However, because the photo time is “12:17” and the photo location is “Ikebukuro Station East Exit” in SNS number “I3” and “12:17” is included in the schedule time (a period from the schedule start time to the schedule end time) and data of advertising space number P2 related to the location of “Ikebukuro Station East Exit” matches in the advertising space table, the processor 401 selects advertising space number “P2.” Also, the processor 401 writes “P2” to the advertising space number determination data in SNS number “I3” of the advertising space number determination table. Thereby, the processor 401 can estimate which advertisement was viewed when the posted data has been posted and store an estimation result thereof.

Also, this weighting may differ according to each advertisement even in the same time period. For example, the weighting of advertisement number “C3” can be set to be larger than the weighting of advertisement number “C1” in a time period from 11:00 to 12:00.

Also, a row in which the total matching degree between the text and the photo is 0% may be deleted from the advertising space number determination table.

### <Step S13>

The processor 401 inputs a weighting value stored in the advertising space number determination table during a contract period to a weighting corresponding to the advertising space number in the advertising space table.

FIG. 12 is a diagram showing an example of an advertising space table when the weighting stored in the advertising space number determination table is stored in the advertising space table.

An advertising space table after the determination of the advertising space number is made (hereinafter also referred to as a post-determination advertising space table) includes an advertising space number, a schedule start time, a schedule end time, a location, a weighting, a unit price, and a unit price after the weighting addition. The processor 401 writes a total weighting value in the advertising space number determination table to the weighting of the advertising space table. In FIG. 12, a case where the weighting of advertising space P1 is updated from “1.0” to “1.3,” the weighting of advertising space P2 is updated from “1.0” to “3.9,” and the weighting of advertising space P3 remains “1.0” is shown. When the processor 401 updates the weighting, the processor 401 calculates the unit price after the weighting addition on the basis of the updated weighting and the unit price. Here, the unit price after the weighting addition of advertising space P1 is updated from “1000” to “1300,” the unit price after the weighting addition of advertising space P2 is updated from “1000” to “3900,” and the unit price after the weighting addition of advertising space P3 remains “1000.”

The processor 401 may be configured to transmit an advertising space number, a weighting, a unit price, and a unit price data after the weighting addition for an advertisement requested by an advertiser to the advertiser who posted the advertisement corresponding to an advertising space number in the post-determination advertising space table as effect measurement results. Here, the advertisement number, the schedule start time, the schedule end time, and the like may also be transmitted. A transmission timing at which the effect measurement results are transmitted may be each certain time or each time when the weighting or the unit price after the weighting addition is updated. Because the effect measurement results are transmitted to the advertiser terminal 80, it is possible to inform the advertiser of a relationship between a weighting and a unit price.

When data transmitted from the advertisement server 40 is received, the advertiser terminal 80 displays the received data on a display screen. Thereby, the advertiser can ascertain a degree to which the user is interested in the advertisement posted by the advertiser with reference to the weighting and the like. Also, it is possible to ascertain a current unit price with reference to the unit price after the weighting addition. Also, because the weighting can be ascertained, the advertiser can ascertain how the unit price has been determined.

### <Step S14>

The processor 401 determines whether a contract period corresponding to a distribution schedule has expired. The processor 401 terminates the process when the contract period has expired and moves the process to step S15 when the contract period has not expired. Even if the process is completed, because the data stored in the post-determination advertising space table is saved, the advertising consignor can pay the advertising cost to the advertising agency on the basis of the unit price after the weighting addition stored in the post-determination advertising space table.

### <Step S15>

When the contract period has not expired, the processor 401 waits for the time of 10 advertisements and then moves the process to step S03.

FIG. 13 is a schematic block diagram showing a configuration of an advertisement management system 1A according to another embodiment.

The advertisement management system 1A includes an acquirer 31 and an analyzer 41.

The acquirer 31 acquires posted data corresponding to at least one of advertising spaces shown in a location where the display device for displaying the advertisement is installed or a period when the advertisement is displayed within posted data posted from the user's terminal device. The analyzer 41 determines a matching degree between a posted element obtained from the acquired posted data and an advertisement element corresponding to the advertisement.

It is possible to ascertain the fact that the effectiveness of the advertisement increases on the basis of posted data posted from the user as the matching degree increases by calculating the matching degree. Also, it can be seen that when the number of pieces of post data with a high matching degree is larger, the more users viewed or were interested in the advertisement. Also, even if posted content is not directly related to the advertisement, because it can be considered that the posted content was posted due to viewing the advertisement, it can be considered that the advertisement was watched. The action of posting posted data is an independent action of the user and there is an advantage in that advertising effects can be aggregated on the basis of this subjective action.

According to the above-described embodiment, because the user's independent operation using an SNS is acquired and analyzed, the effect of the advertisement using a result estimated to be an operation performed due to watching the advertisement can be obtained.

Also, according to the above-described embodiment, in response to the needs of the advertisement consignor, the optimal advertising space according to the advertisement content can be determined using the SNS to obtain the optimal advertising effect and the advertisement can be scheduled according to the content of the advertisement.

Also, according to the above-described embodiment, it is possible to measure the effectiveness of the advertisement by ascertaining the relevance with the advertising space in real-time on the basis of the posted data. Also, it is possible to calculate a unit price considering the advertising effect using weightings considering the relevance with the advertising space on the basis of the posted data.

Thus, advertising agencies can research advertising spaces that are likely to spread the SNS as a differentiation measure from other companies in the same industry and posted data related to advertisements can be spread by the SNS as a service that can be ascertained as advertising effectiveness. The advertising consignor can also acquire advertising spaces that make it easy for advertisement-related content to be spread by the SNS and a high advertising effect can be obtained. Thus, it can be said that both the advertising agency and the advertising consignor are beneficial.

Also, a program for implementing the function of the processor in FIG. 1 may be recorded on a computer-readable recording medium and the program recorded on the recording medium may be read and executed by a computer system, such that construction management may be performed. Also, it is assumed that the “computer system” used here includes an operating system (OS) or hardware such as peripheral devices.

Also, the “computer system” is assumed to include a homepage-providing environment (or a display environment) if a WWW system is used.

Also, the “computer-readable recording medium” refers to a flexible disc, a magneto-optical disc, a read-only memory (ROM), a portable medium such as a compact disc-ROM (CD-ROM), or a storage device such as a hard disk embedded in the computer system. Furthermore, the “computer-readable recording medium” is assumed to include a medium that holds a program for a constant period of time, such as a volatile memory inside a computer system serving as a server or a client. Also, the above-described program may be a program for implementing some of the above-described functions. Also, the above-described program may be a program capable of implementing the above-described function in combination with a program already recorded on the computer system. Also, the above-described program may be stored in a prescribed server and the program may be distributed (downloaded or the like) via a communication circuit in response to a request from another device.

Although embodiments of the present invention have been described in detail above with reference to the drawings, specific configurations are not limited to the embodiments and other designs and the like may also be included without departing from the scope of the present invention.

### REFERENCE SIGNS LIST

1, 1A Advertisement management system
10, 10a, 10b, 10c Terminal
20 SNS server
30 Analysis server
31 Acquirer
40 Advertisement server
41 Analyzer
50 Distribution server
70 Display
80 Advertiser terminal
301 SNS acquirer
302 SNS analyzer
303 SNS information table storage
401 Processor
402 Advertisement database
403 Advertising space setter

1. An advertisement management system comprising:
an acquirer configured to acquire posted data corresponding to at least one of advertising spaces shown in a location where a display device for displaying an advertisement is installed or a period when the advertisement is displayed within posted data posted from a terminal device of a user; and
an analyzer configured to calculate a matching degree between a posted element obtained from the acquired posted data and an advertisement element according to the advertisement.

2. The advertisement management system according to claim 1, the advertisement management system comprising:
a processor configured to calculate a price for displaying the advertisement on the basis of a weighting according to the matching degree.

3. The advertisement management system according to claim 2,
wherein the processor determines which advertisement the posted data corresponds to in the advertising space on the basis of the matching degree.

4. The advertisement management system according to claim 1,
wherein the analyzer calculates a matching degree between at least one of a time and a location in which photo data included in the posted data is obtained in a photography process and at least one of the advertising space of the advertisement and the location of the display device for displaying the advertisement.

5. The advertisement management system according to claim 1,
wherein the analyzer calculates a matching degree between a feature of photo data included in the posted data and a feature of an image corresponding to the advertisement.

6. The advertisement management system according to claim 1,
wherein the analyzer calculates a matching degree between at least one of a time and a location in which the posted data was posted and at least one of an advertising space of the advertisement and a location of the display device for displaying the advertisement.

7. The advertisement management system according to claim 1, the advertisement management system comprising:
a keyword storage configured to store identification information for identifying the advertisement and at least one keyword related to the advertisement,
wherein the analyzer calculates a matching degree of text on the basis of the number of keywords matching a string obtained from text included in the posted data within the at least one keyword.

8. (canceled)

9. An advertisement management method to be executed by a computer, the advertisement management method comprising:
executing a process of acquiring posted data corresponding to at least one of advertising spaces shown in a location where a display device for displaying an advertisement is installed or a period when the advertisement is displayed within posted data posted from a terminal device of a user; and
executing, by an analyzer, a process of calculating a matching degree between a posted element obtained from the acquired posted data and an advertisement element according to the advertisement.
